(19) United States
(12) Patent Application Publication
(10) Pub. No.: US 2006/0123598 A1
(43) Pub. Date: Jun. 15, 2006

(54) Floor hinge

(75) Inventor: Hyungtae Park, Kyunggi-do (KR)

Correspondence Address: BACON & THOMAS, PLLC, 625 SLATERS LANE, FOURTH FLOOR, ALEXANDRIA, VA, 22314, US

(73) Assignee: Samhwa World Co., Ltd, Seoul (KR)

(21) Appl. No.: 10/559,339

(22) PCT Filed: Jun. 1, 2004
(86) PCT No.: PCT/KR04/01327

§ 371 Date: Dec. 5, 2005

(30) Foreign Application Priority Data
Jun. 3, 2003 (KR) 20-2003-0017359

(51) Int. Cl. E05D 7/08

(52) U.S. Cl. 16/378

(57) ABSTRACT

Disclosed herein is a floor hinge. The floor hinge for doors is constructed to automatically close and open door using shock absorbers (50). The floor hinge of the present invention has a length which is considerably shorter than a conventional floor hinge, thus being light in weight, being easily transported, and remarkably enhancing manufacturability.

### TECHNICAL FIELD

The present invention relates, in general, to floor hinges for doors, and, more particularly, to a floor hinge, the length of which is less than half of the length of a conventional floor hinge, thus achieving easy construction and installation.

### BACKGROUND ART

Generally, doors are mounted at an entrance of a building to be opened in a single direction or in both directions. The door is connected at a predetermined position to the building by a hinge, which returns the door opened by an external force to an original state of the door, that is, a closed state, by a restoring force.

There has been widely used a hinge which is installed at a predetermined position on the door in the form of a jointed device, or embedded in the floor under the door. In the latter case, the hinge embedded in the floor is usually designated a floor hinge.

Such a conventional floor hinge includes a hinge shaft which is provided in an elongate casing to be rotatably coupled to a lower end of the door. A piston connected to a piston rod is longitudinally placed to be reciprocated, in response to a rotation of the hinge shaft. Further, a return spring is coupled to the piston rod.

As such, the floor hinge placed in a lengthwise direction is constructed so that the return spring and the piston are operated by the long piston rod. Thus, the length of the casing is inevitably increased in a lengthwise direction, and thereby, an area occupied by the floor hinge is increased. Further, because all elements of the floor hinge are made of metal, a larger amount of metal is required due to the long floor hinge, thus causing increase in weight of the floor hinge. Therefore, it is inconvenient to produce, carry, and install the floor hinge.

### DISCLOSURE OF THE INVENTION

Accordingly, the present invention has been made keeping in mind the above problems occurring in the prior art, and an object of the present invention is to provide a floor hinge which includes a casing with an improved internal structure, so that the floor hinge has operational efficiency similar to or better than a conventional floor hinge while the volume of the floor singe is greatly reduced, thus achieving convenient production, transportation, and construction.

Another object of the present invention is to provide a floor hinge which includes a casing with an improved internal structure to allow a door to be smoothly closed.

A further object of the present invention is to provide a floor hinge which includes a casing with an improved internal structure to achieve easy manufacture of the floor hinge, and reduce manufacturing costs of the floor hinge.

In order to accomplish the above object, the present invention provides a floor hinge embedded in a floor of a building under a door, and including a cam 60 coupled to a hinge shaft 10 in a rectangular box-shaped casing. The floor hinge includes upper and lower plates 20 and 30 fitted over the hinge shaft 10 projecting from the casing 100 to be moved in a lengthwise direction of the upper and lower plates by an operation of the cam 60, and a bent “T”-shaped support unit 40 including a plate support part 48 and a rod support part 46, wherein the plate support part 48 is fastened to a lower surface of a front end of the lower plate 30 using a bolt 32, and the rod support part 46 having on both sides thereof screw holes 42 projects to an outside of the lower plate 30 so that a pair of piston rods 51 extending from a pair of shock absorbers 50 is screwed to the corresponding screw holes 42, and a rear portion of each of the shock absorbers 50 is supported by the casing. Thereby, when the door is opened, the hinge shaft 10 rotates the cam 60, and each of the piston rods moves in conjunction with the cam, thus compressing each of the shock absorbers, and the piston rods are restored to original states thereof by a restoring force of each of the shock absorbers, thus rotating the hinge shaft in a reverse direction, thereby closing the door.

An end of each of the shock absorbers 50 is supported by a support bolt 54 fitted into a predetermined portion of the casing 100, and a pair of rail guide grooves 44 is provided on an underside of the support unit 40 at a predetermined interval to slide along rails 108 provided on a bottom plate of the casing 100.

In another aspect of this embodiment, an additional screw hole 43 is provided on a predetermined portion of the rod support part 40, a hollow piston 90 is fastened to the screw hole 43, and a cylinder unit 98 is provided on a predetermined portion of the casing. In this case, while the door is closed by the restoring force of each of the shock absorbers, the hollow piston is inserted into a cylinder body 99 of the cylinder unit, and an oil path is provided on a predetermined portion of the cylinder unit.

A steel ball 94 is held in the hollow piston 90, thus preventing a counter flow of the oil toward the support unit 40 while the door is closed, and a guide unit 120 is provided on a predetermined portion of a bottom plate 110 of the casing to guide the hollow piston.

In yet another aspect of this embodiment, the rear portion of each of the shock absorbers 50 is fastened to a plug 80 coupled to the casing, using a screw.

### BRIEF DESCRIPTION OF THE DRAWINGS

FIG. 1 is a partially cutaway perspective view of a floor hinge, according to the first embodiment of the present invention;

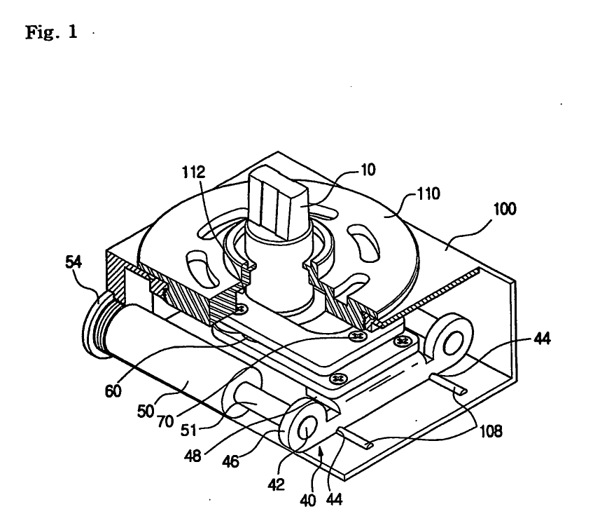

FIG. 2 is a partially cutaway perspective view of a casing of the floor hinge, according to the first embodiment of the present invention;

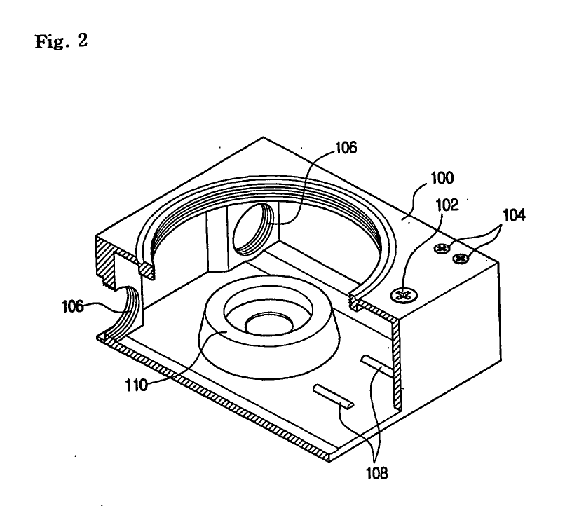

FIGS. 3 and 4 are views to show operations of the floor hinge, according to the first embodiment of the present invention;

FIG. 5 is a perspective view to show important parts of the floor hinge, according to the first embodiment of the present invention;

FIG. 6 is an exploded perspective view of a floor hinge, according to the second embodiment of the present invention;

FIG. 7a and FIG. 7b is a schematic view of the floor hinge, according to the second embodiment of the present invention; and

FIG. 8 is a schematic view to show important parts of the floor hinge, according to the second embodiment of the present invention.

### DESCRIPTION OF REFERENCE CHARACTERS OF IMPORTANT PARTS

10: hinge shaft, 20: upper plate, 22: rod,

30: lower plate, 32: bolts, 40: support unit,

50: shock absorbers, 51: piston rods,

54: support bolts, 60: cam, 72: rollers, 80: plugs,

90: hollow piston, 98: cylinder unit, 100: casing,

120: guide unit

### BEST MODE FOR CARRYING OUT THE INVENTION

### FIRST EMBODIMENT

A floor hinge according to the present invention includes a hinge shaft 10 that projects from an interior to an exterior of a rectangular box-shaped casing 100. A lower end of the hinge shaft 10 is supported by a shaft housing provided on a bottom of the casing 100, while an upper portion of the hinge shaft 10 is inserted into a hole provided on a predetermined portion of a lid 110 to be rotatably supported by the hole. A projecting upper end of the hinge shaft 10 is coupled to a door (not shown). A bearing seat 112 is provided on a lower surface of the lid 110, and a bearing (not shown) is seated in the bearing seat 112 to reduce the friction during the rotation of the hinge shaft 10.

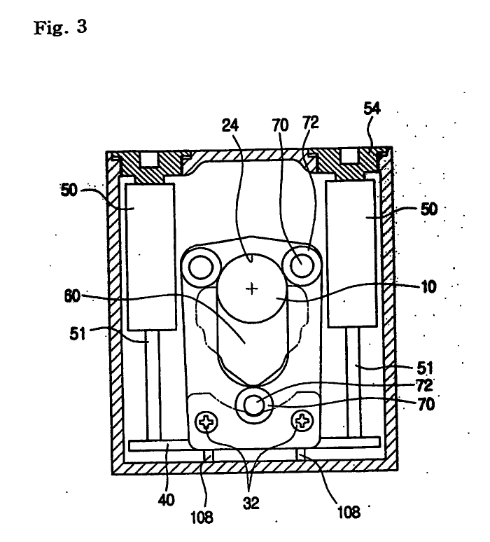

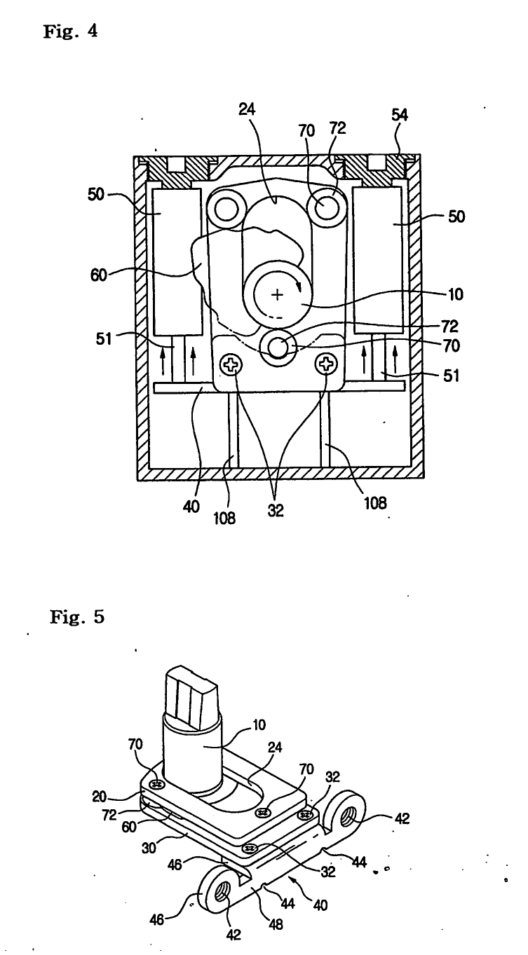

As shown in FIG. 5, upper and lower plates 20 and 30 each having a longitudinal actuating hole 24 are fastened to each other by a plurality of bolts 70 so that the hinge shaft 10 is inserted into the actuating holes 24. In this case, a roller 72 is fitted over each bolt 70, thus allowing the upper and lower plates 20 and 30 to be spaced apart from each other by a predetermined interval. Further, a cam 60 is interposed between the upper and lower plates 20 and 30, and is mounted to the hinge shaft 10 to rotate along with the hinge shaft 10. FIGS. 3 and 4 schematically show the shape and rotation of the cam, according to the first embodiment of the present invention.

A “T”-shaped plate is bent at predetermined positions thereof to provide a support unit 40 having a plate support part 48 and a rod support part 46. The plate support part 48 is fastened to the lower plate 30 using screws, after coming in contact with the lower plate 30. The support unit is constructed so that the rod support part 46 having on both sides thereof screw holes 42 is projected to an outside of the lower plate 30.

The floor hinge also includes shock absorbers 50, with a piston rod 51 extending from each of the shock absorbers 50. Each piston rod 51 is firmly screwed to each screw hole 42 formed as described above. A rear portion of each shock absorber 50 is supported by a support bolt 54 fitted into a rear portion of the casing 100. In a detailed description, a protrusion is provided on a predetermined portion of each support bolt 54, and an insert hole is provided on the rear portion of each shock absorber 50 so that the protrusion is inserted into the insert hole. It is preferable that the protrusion of each support bolt 54 be inserted into an associated insert hole to control the movement of each shock absorber. In order to more reliably couple each support bolt 54 to an associated shock absorber 50, it is also preferable that internal threads and external threads be provided on each support bolt 54 and the rear portion of each shock absorber 50, respectively.

According to this embodiment, the shock absorbers 50 are provided between the rod support part 46 and the support bolts 54. In this case, a hydraulic cylinder, a gas shock absorber, etc. may be employed as the shock absorber. Of course, a spring having an elastic restoring force may be employed as the shock absorber.

A pair of rail guide grooves 44 is provided on the underside of the rod support part 46 at a predetermined interval. A pair of rails 108 corresponding to the rail guide grooves 44 is provided on the bottom of the casing 100 to slidably engage the rail guide grooves 44.

The rail guide grooves 44 and the rails 108 may comprise one rail guide groove 44 and one rail 108. Alternatively, as described above, the rail guide grooves 44 and the rails 108 may comprise two or more rail guide grooves 44 and two or more rails 108, as necessary.

The reference numeral 102 denotes an oil supply hole to supply oil to the casing 100, and the reference numeral 104 denotes pressure control bolts to control the internal pressure of the casing 100.

The operation of the present invention will be described below.

The floor hinge of the present invention is similar to a conventional floor hinge in that the casing 100 contains oil. However, in the case of the floor hinge according to the present invention, there is no necessity for feeding oil into the floor hinge.

When a user opens the door coupled to the hinge shaft 10, the hinge shaft 10 is rotated. As the hinge shaft 10 rotates, as shown in FIG. 4, the cam 60 mounted to the hinge shaft 10 is rotated while pushing the rollers 72. At this time, the upper and lower plates 20 and 30 move backward, thus changing the position of the hinge shaft 10 in the actuating holes 24. Simultaneously, the shock absorbers 50, firmly supported by the rod support part 46 of the support unit 40 coupled to the lower plate 30, are compressed.

Subsequently, when the door is released, the shock absorbers 50 operate to push the lower plate 30 coupled to the support unit 40. Simultaneously, the rollers 72 which are fitted over the bolts 70 fastening the upper and lower plates 20 and 30 to each other push the cam 60 so that the cam 60 returns to an original position thereof. Thus, the hinge shaft 10 rotates to return to an original position thereof, so that the door is automatically closed.

When the door is opened or closed, the rail guide grooves 44 provided on the underside of the support unit 40 slide along the rails 108 provided on the bottom of the casing 100. Such a construction allows a rectilinear reciprocating motion to be reliably performed without the support unit deviating from a predetermined course.

### SECOND EMBODIMENT

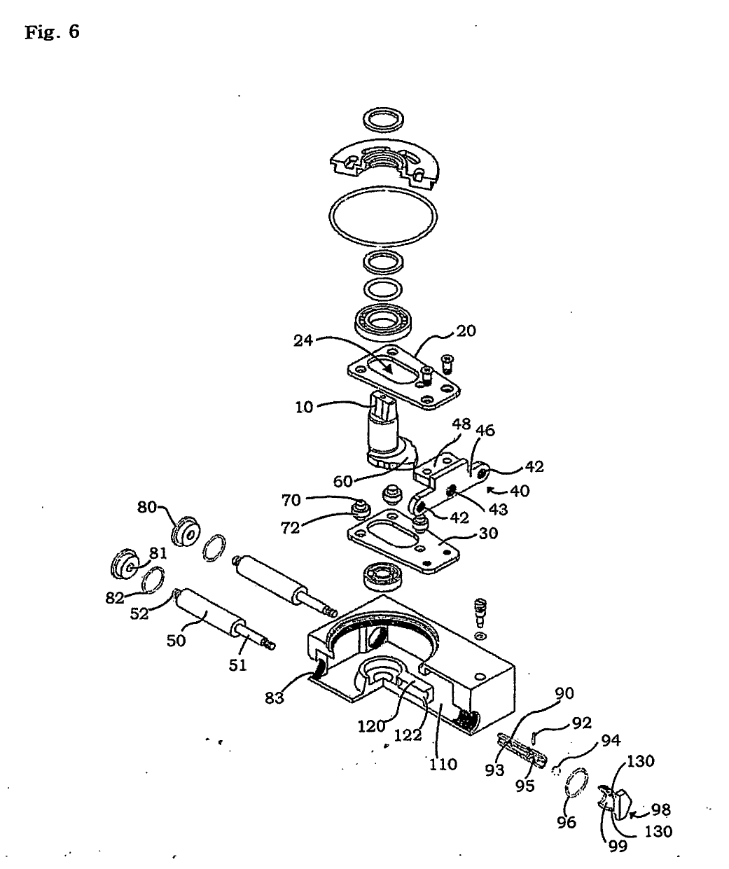

FIG. 6 is a view to show another embodiment of the present invention. A guide unit 120 is provided on a bottom plate 110 of a casing, so that a hollow piston 90 is inserted into a guide hole 122 of the guide unit 120. An end of the hollow piston 90 is screwed to a screw hole 43 which is additionally provided on a rod support part 46 of a support unit 40. Thus, the hollow piston 90 supported by the rod support part 46 moves in conjunction with the rod support part 46. Further, the hollow piston 90 is guided by the guide unit 120 so as to rectilinearly reciprocate without shaking from side to side. That is, when a door is being opened, a cam 60 is rotated to push rollers 72. Thus, upper and lower plates 20 and 30 coupled to the rollers 72 are moved in conjunction with the rollers 72, and thereby, the support unit 40 mounted to the lower plate 30 is moved. Further, the hollow piston 90 which is supported by the screw hole 43 additionally provided on the rod support part 46 of the support unit is moved.

The hollow piston comprises a hollow pipe. A first portion 93 of the hollow pipe facing the screw hole 43 has a smaller inner diameter, while a second portion 95 of the hollow pipe opposite to the first portion 93 has a larger inner diameter. Preferably, a steel ball 94 is held in the second portion 95 by a support pin 92. The operation of the steel ball will be described later herein.

A cylinder unit 98 is coupled to a predetermined portion of the casing at a position around the hollow piston. Preferably, an O-ring 96 is provided at a junction between the casing and the cylinder unit to prevent oil from escaping out of the casing.

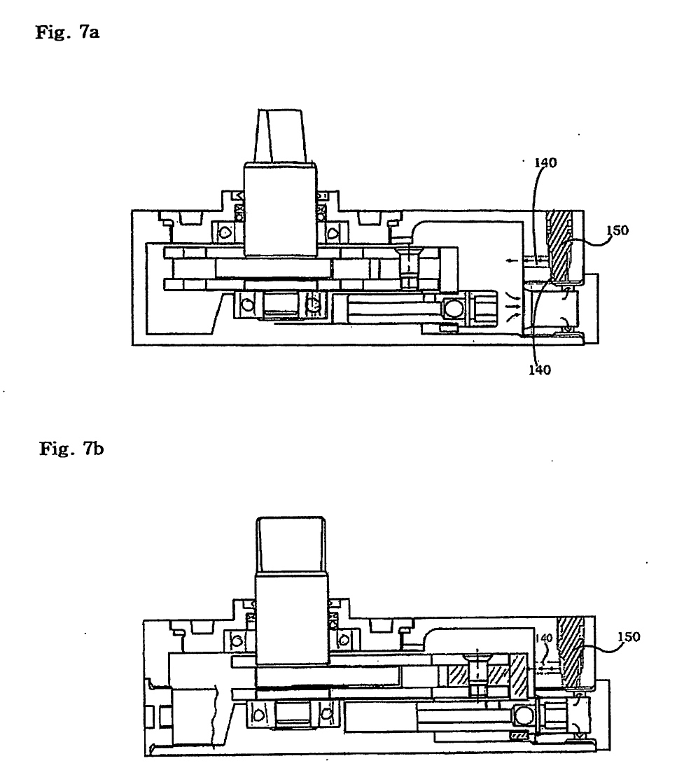

When the open door is closed by restoring forces of the shock absorbers 50, the hollow piston 90 moves to the cylinder unit 98 to be inserted into a cylinder body 99 of the cylinder unit 98. At this time, oil existing between the steel ball 94 of the hollow piston 90 and the cylinder body 99 of the cylinder unit 98 is compressed, thus preventing the door from being abruptly closed. In a detailed description, when the door is changed from the open state of FIG. 7a to the closed state of FIG. 7b, by restoring forces of the shock absorbers, the hollow piston moves to the cylinder unit, and the door is slowly closed by oil existing between the hollow piston and the cylinder unit. Further, the steel ball moves toward the screw hole 43 by the oil, thus closing a junction between the first portion 93 of the hollow piston with the smaller inner diameter and the second portion 95 of the hollow piston with the larger inner diameter, and thereby, preventing oil from flowing backward.

In order to control a closing speed of the door, a manufacturer has only to adjust a size of a drain path for oil confined between the steel ball 94 of the hollow piston and the cylinder body 99 of the cylinder unit. In the present invention, as shown in FIGS. 7a and 7b, at least one oil drain hole 130 is provided at a predetermined position on the cylinder unit, and coupled to an oil path 140 through which oil is drained. Preferably, an adjusting bolt 150 is inserted into the casing to adjust an area of the oil path.

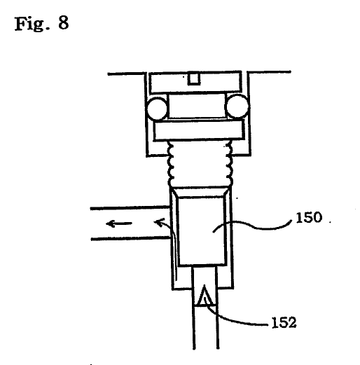

As shown in FIG. 8, a notch 152 may be provided on a predetermined portion of the adjusting bolt 150 to be tapered in a direction from a lower end to an upper end of the notch 152. Thus, as the adjusting bolt is turned to be deeply inserted into the oil path 140; the area of the oil path 140 is reduced.

Further, the rear portion of each shock absorber is not directly screwed to the casing, but a plug 80 is fastened to a threaded part 83 provided at a predetermined position on the casing, and then a screw hole 81 provided on a predetermined portion of the plug 80 engages a screw 52 provided at a predetermined position on each shock absorber 50, as shown in FIG. 6. The reason why each shock absorber is fastened to the casing via the plug 80 is that it is more difficult to precisely machine the casing itself, compared to a small element, that is, the plug 80.

### INDUSTRIAL APPLICABILITY

As described above, the present invention provides a floor hinge which includes a casing with an improved internal structure, so that the floor hinge has operational efficiency similar to or better than a conventional floor hinge while the volume of the floor hinge is greatly reduced.

The present invention improves the internal structure of the casing of the floor hinge, thus allowing a door to be smoothly closed at a constant speed without closing abruptly, due to the action of oil existing between a hollow piston and a cylinder unit.

Further, the present invention improves the internal structure of the casing of the floor hinge, thus achieving easy manufacture of the floor hinge, and reducing manufacturing costs of the floor hinge.

1. A floor hinge embedded in a floor of a building under a door, and comprising a cam (60) coupled to a hinge shaft (10) in a rectangular box-shaped casing, the floor hinge comprising:
upper and lower plates (20 and 30) fitted over the hinge shaft (10) projecting from the casing (100) to be moved in a lengthwise direction of the upper and lower plates by an operation of the cam (60); and
a support unit (40) having a bent plate shape, and comprising a plate support part (48) and a rod support part (46),
wherein the plate support part (48) is fastened to a lower surface of a front end of the lower plate (30) using a bolt (32), and the rod support part (46) having on both sides thereof screw holes (42) projects to an outside of the lower plate (30) so that a pair of piston rods (51) extending from a pair of shock absorbers (50) is screwed to the corresponding screw holes (42) and a rear portion of each of the shock absorbers (50) is supported by the casing, so that, when the door is opened, the hinge shaft (10) rotates the cam (60), and each of the piston rods moves in conjunction with the cam, thus compressing each of the shock absorbers, and the piston rods are restored to original states thereof by a restoring force of each of the shock absorbers, thus rotating the hinge shaft in a reverse direction, thereby closing the door.

2. The floor hinge according to claim 1, wherein an end of each of the shock absorbers (50) is supported by a support bolt (54) fitted into a predetermined portion of the casing (100), and
a pair of rail guide grooves (44) is provided on an underside of the support unit (40) at a predetermined interval to slide along rails (108) provided on a bottom plate of the casing (100).

3. The floor hinge according to claim 1, further comprising:
an additional screw hole (43) provided on a predetermined portion of the rod support part (46);
a hollow piston (90) fastened to the screw hole;
a cylinder unit (98) provided on a predetermined portion of the casing;
wherein, while the door is closed by the restoring force of each of the shock absorbers (50), the hollow piston (90) is inserted into a cylinder body (99) of the cylinder unit (98), and an oil path (130) is provided on a predetermined portion of the cylinder unit, thus preventing the door from closing abruptly by an action of oil between the hollow piston (90) and the cylinder body (99) of the cylinder unit (98).

4. The floor hinge according to claim 3, wherein a steel ball (94) is held in the hollow piston (90), thus preventing a counter flow of the oil toward the support unit (40) while the door is closed.

5. The floor hinge according to claim 3, further comprising:
a guide unit (120) provided on a predetermined portion of a bottom plate (110) of the casing to guide the hollow piston (90).

6. The floor hinge according to claim 1, wherein the rear portion of each of the shock absorbers (50) is fastened to a plug (80) coupled to the casing, using a screw.

7. The floor hinge according to claim 4, further comprising:
a guide unit (120) provided on a predetermined portion of a bottom plate (110) of the casing to guide the hollow piston (90).

8. The floor hinge according to claim 3, wherein the rear portion of each of the shock absorbers (50) is fastened to a plug (80) coupled to the casing, using a screw.
